(19) United States
(12) Patent Application Publication
(10) Pub. No.: US 2003/0039008 A1
(43) Pub. Date: Feb. 27, 2003

(54) Optical grating for coarse wavelength division multiplexing (CWDM) applications

(76) Inventor: Michael Davies, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/227,800

(22) Filed: Aug. 27, 2002

Related U.S. Application Data
(60) Provisional application No. 60/314,649, filed on Aug. 27, 2001.

(51) Int. Cl. G02B 6/34; H04J 14/02

(52) U.S. Cl. 359/130; 385/37

(57) ABSTRACT

Active temperature compensation for optical devices is typically employed in optical networks in order to ensure that optical wavelength passbands defined by the optical device do not shift significantly in optical wavelength when the optical device is subjected to temperature variations. Shifting of the optical wavelength passbands typically results in optical signals propagating therein to be attenuated in optical power in response to the temperature variation. Although some optical devices, such as those which employ thin film filter technology, do not require active temperature compensation, a majority of waveguide optical device such as array waveguide grating device do require active company temperature compensation. A novel optical device is thus disclosed which facilitates propagation of optical signals therein without relying on temperature compensation schemes.

This application claims priority from U.S. Provisional Application No. 60/314,649 filed Aug. 27, 2001.

### FIELD OF THE INVENTION

The area of the invention relates to optical networks and more specifically to the area of coarse wavelength division multiplexing (CWDM) optical networks.

### BACKGROUND OF THE INVENTION

Wavelength division multiplexing (WDM) has been used commercially to increase the bandwidth of fibre optic networks. WDM involves combining different optical signals with each having different center wavelengths along a same optical fiber. These optical signals propagate in optical wavelength channels, where the optical wavelength channels defines wavelength ranges for each optical signal within which the optical signal is free to shift in optical wavelength before it causes problems with the optical network. Typically, each optical wavelength channel sets a range within which the optical signal at a predetermined wavelength resides. If the optical signal falls out of this range then problems such as crosstalk between adjacent channels may result.

Multiplexers are optical devices that are used to combine multiple optical signals onto a single multiplexed optical signal containing the multiple optical signals. The multiplexed optical signal thus has a number of optical wavelength channels defined therein, with each optical wavelength channel propagating an optical signal therein. Typically, this multiplexed signal propagates along a single optical fiber to a demultiplexing optical device, where the demultiplexing optical device receives the multiplexed optical signal and performs a step of demultiplexing. Demultiplexing involves separating individual optical signals contained within the multiplexed optical signal. Typically, each of the optical signals is provided to a receiver after demultiplexing. As the optical devices used for multiplexing and demultiplexing have evolved, they have facilitated combining of an increasing number of optical signals for propagation within a multiplexed optical signal along a same optical single fiber.

In order to prevent crosstalk between adjacent optical signals having different wavelengths it is necessary to ensure that the individual optical signals propagating within each predetermined optical wavelength passband stay within the predetermined wavelength range for that optical wavelength channel. These optical wavelength passbands are themselves limited to a predetermined wavelength range or band for each optical device. Consequently, as the number of optical signals increases, such as in dense WDM (DWDM) optical networks, the wavelength range for each optical wavelength channel decreases, thus a reduction in channel width and passband width requires tremendous precision on the part of the optical components used to manipulate the optical signals within the specific wavelength channels as well as increased precision of the laser sources used to generate each of the optical signals. Since if the laser sources drift in wavelength when generating optical signals the undesired effects, such as crosstalk, in the optical network may result.

It is know to those of skill in the art that many optical devices used in WDM networks are thermally sensitive. Thermal sensitivity of optical devices results from optical components within the optical device expanding or contracting in response to the changing thermal conditions to which the optical components within the optical device are subjected. Expansion and contractions of even fractions of a micron are typically sufficient to cause optical signals propagating through these components to incur undesired effects as a result; for instance, unwanted crosstalk between adjacent optical signals being an example thereof. To reduce the effects of thermal sensitivity of optical components, optical devices employing these components are typically designed and built into the optical device in such a manner as to provide some form of compensation for thermal effects.

The combination of precise components and additional equipment for active thermal stabilization of the optical device results in very expensive assemblies that constantly consume electrical power. For example, diode lasers used as light sources for generating the optical signals in DWDM applications require cooling of the laser source in order to maintain a precise optical signal wavelength. In applications where the optical wavelength of the diode laser is allowed to vary in wavelength within a predetermined range there is typically little need for cooling the laser diode chip.

The typical method of cooling a diode laser source is to incorporate a thermoelectric cooler (TEC) into the diode laser package. Unfortunately, these TECs consume significant amounts of electrical power. Therefore, in many applications, it is preferable to use simpler, more reliable and less expensive components associated with fewer optical signals despite the relative loss of total bandwidth because of supporting fewer optical signals. Of course, the larger the physical size of an optical device the more electrical energy is consumed to provide adequate thermal stabilization to the optical device.

It would be advantageous to have a reliable, thermally stable, and inexpensive CWDM optical device for use in low optical channel count fiber optic systems, where such a device would ideally allow for a minimal physical package size.

### SUMMARY OF THE INVENTION

In accordance with the invention there is provided a CWDM optical device comprising: an input port for receiving a multiplexed CWDM optical signal supporting a plurality of optical signals each within a different optical wavelength channel; a plurality of output ports; and, an optical grating in optical communication with the input port, the optical grating for separating the plurality of optical signals into individual optical signals in dependence upon a wavelength of each of the optical signals, the CWDM optical device having an optical wavelength passband defined for each optical signal, the optical wavelength passband having a width for passing a substantial portion of optical power within each optical signal received at the input port to a respective output port from the plurality of output ports, the optical wavelength passband width for each optical wavelength channel being sufficient such that a change in temperature within a wide range of temperature values to which the CWDM optical device is subjected results in little or no change in optical power of each optical signal within a channel when propagated from the input port to a respective output port, the CWDM optical device additionally for supporting optical wavelength passbands that provide optical isolation between adjacent optical signals propagating within adjacent optical wavelength channels when the optical device is subjected to the temperature variation.

In accordance with an aspect of the invention there is provided a method of filtering a CWDM optical signal supporting a plurality of optical wavelength channels, comprising the steps of: providing an optical device for receiving the CWDM optical signal containing a multiple of optical signals at different optical wavelengths; filtering an individual optical signal using an optical component having an optical wavelength passband having a center wavelength at a center wavelength of the optical signal for each of the multiple optical wavelength channels of a multiplexed signal received by the optical device; in the absence of temperature stabilization unique to the optical component, other than substantially attenuating a filtered individual optical signal by the optical device when the optical device undergoes a temperature variation, and, in the absence of temperature stabilization unique to the optical component, other than substantially attenuating an adjacent optical signal located adjacent the optical signal when the device undergoes a temperature variation.

In accordance with an aspect of the invention there is provided a method of filtering a CWDM optical signal supporting a plurality of optical wavelength channels, comprising the steps of: providing an optical demultiplexer absent temperature stabilization thereof and having a plurality of passbands, each associated with an optical wavelength channel; and, demultiplexing an optical signal having channel spacing such that a channel falls within a passband of the plurality of passbands and such that two of the optical signals other than fall within a same passband over an single period of the optical demultiplexer, wherein variations in temperature to the optical demultiplexer that arise during normal use thereof result in a signal within a same wavelength channel falling within a same passband of the demultiplexer.

### BRIEF DESCRIPTION OF THE DRAWINGS

Exemplary embodiments of the invention, will now be described, in conjunction with the drawings, in which:

FIG. 1a is a diagram of exemplary channel spacing for a CWDM multiplexed optical signal;

FIG. 1b is a diagram of exemplary channel spacing for a DWDM multiplexed optical signal;

FIG. 2a shows a prior art thin film filter technology low optical wavelength channel count optical device;

FIG. 2b shows a prior art arrayed waveguide device (AWG) for propagating and manipulating optical signals when used with this high optical wavelength channel count optical device;

FIG. 3a illustrates a CWDM optical wavelength passband spectral profile associated with a typical prior art optical device;

FIG. 3b illustrates a wavelength profile of the output of a laser source for generating an optical signal for use within a CWDM optical network;

FIG. 4 illustrates a compact integrated optical grating optical device that either functions as an optical multiplexer or an optical demultiplexer for carrying out embodiments of the invention;

FIG. 5 illustrates an optical wavelength passband for a first CWDM optical device that has no temperature compensation;

FIG. 6 illustrates a second set of “flat-top” optical wavelength response curves associated with a second CWDM optical device without temperature stabilization; and,

FIG. 7 illustrates four optical response curves for the second CWDM optical device supporting four optical wavelength channels with “flat top” response.

### DETAILED DESCRIPTION OF THE INVENTION

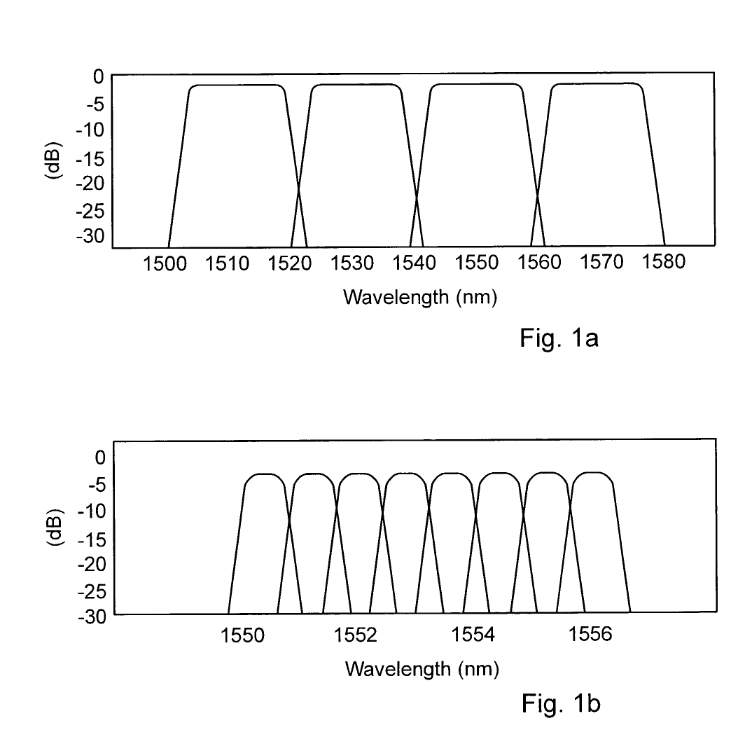

Optical devices that support wide optical wavelength channels are referred to as being coarse wavelength division multiplexing (CWDM) devices, and optical devices that support narrow optical wavelength channels are referred to as being dense wavelength division multiplexing (DWDM) devices. Referring to FIGS. 1a and 1b, exemplary optical wavelength channels are shown for a CWDM device (FIG. 1a) and a DWDM device (FIG. 1b). Of course, the wavelength spacing shown is intended as a general description and does not assume that other optical wavelength channel configurations are not possible. As is seen in these figures, for a CWDM system there is more tolerance in optical wavelength shifts for a laser source generating the optical signal propagating within that optical wavelength channel, where a same tolerable shift in optical wavelength for a CWDM device results in a catastrophic problem for DWDM devices because of their narrower spaced optical wavelength channels.

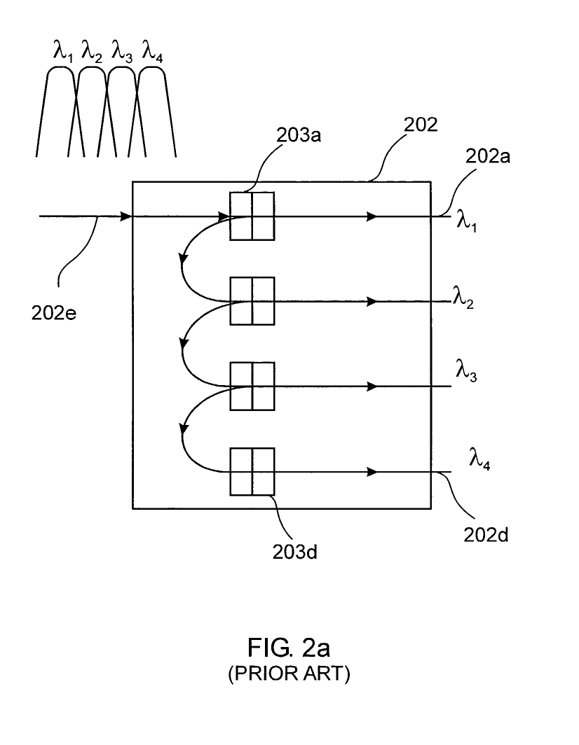

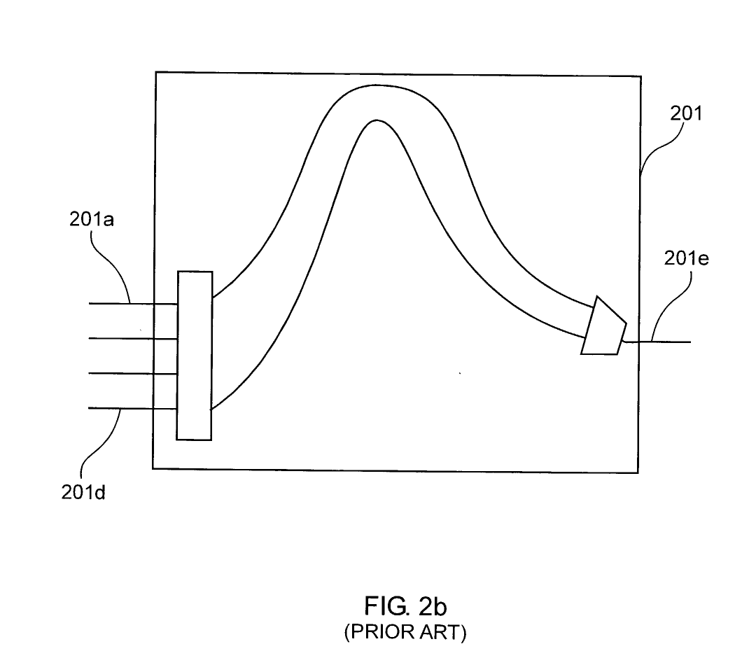

Optical devices employing thin film filter technology are typically used in low channel count CWDM optical devices, an example of which is shown in FIG. 2a. The optical device 202 is useable as both a multiplexer and a demultiplexer for CWDM optical signals. When used as a demultiplexer, a multiplexed optical signal supporting multiple optical signals at different wavelengths is provided to an input port 202e, the multiplexed signal is partially reflected and partially transmitted through a first thin film filter 203a. Partially reflecting the multiplexed signal causes all but a single optical signal from the multiplexed optical signal to be provided to a second thin film filter 203b. Partially transmitting of the optical signal through this first thin film filter 203a results in a first optical signal, lambda 1 in this case, to be provided on a first output port 202a of the CWDM device. Thus, through the process of partially reflecting and partially transmitting, portions of the multiplexed optical signal are demultiplexed into individual optical signals at different optical wavelengths, with each of these optical signals being provided to output ports 202a through 202d. Of course, the same optical device 202 also functions as a multiplexer, where individual optical signals at different wavelengths are provide to input ports 202a through 202d and using the thin film filters as combiners, in a process of partial optical transmission and partial optical reflection, the individual optical signals are combined into a single multiplexed optical signal supporting the multiple optical signals at different wavelengths. This multiplexed signal then provided to port 202e on the device. Thus, as with the AWG optical device 201, the thin film filter optical device 202 also functions as a multiplexer and a demultiplexer.

When packaging of thin film optical devices, packaging constraints are placed on the thin film filter optical device because the optical fibres used to optically couple the thin film filters 203a through 203d are typically looped inside the package. It is understood that to prevent excessive attenuation the minimum bend radius of the looped fibre should preferably be no less then 60 mm or roughly 2.5 inches. Therefore, it is not surprising that optical devices of this type have a generally large device footprint, where sizes of 140 mm by 105 mm are not uncommon.

Typically, in DWDM applications, arrayed waveguide devices (AWG)s are used within the optical devices for propagating and manipulating the optical wavelength channels for high channel count optical devices. An example of an AWG device 201 is shown in prior art FIG. 2b. Optical devices using AWGs typically have the AWG configured in such a manner as to form a multiplexer or demultiplexer. These AWG multiplexers or demultiplexers are used for receiving many narrow wavelength spaced optical signals, such as those in DWDM systems, for multiplexing them onto a single multiplexed optical signal supporting the many optical signals propagating within the narrow optical wavelength channels defined by the optical device, or take in a single multiplexed optical signal and demultiplex the multiplexed optical signal into individual optical signals at their respective different optical wavelengths corresponding to the different narrow optical wavelength bands for the DWDM optical wavelength channels. Each of the optical signals, after the process of demultiplexing, is then provided to output ports of the optical device. Thus, in a multiplexer configuration, ports 201a through 201d function as input ports, with each having a separate optical signal provided thereto, and the AWG 201 combines these separate optical signals to form a multiplexed output signal, as shown in FIG. 1b, at port 201e.

In a demultiplexer configuration, port 201e functions as an input port for receiving a multiplexed optical signal, as shown in FIG. 1b, and ports 201a through 201d function as output ports, where each output port thus provides a separate optical signal, at a different wavelength, derived from the multiplexed input signal supporting multiple optical signals at different wavelengths. Both types optical devices 202 and 201 thus have optical wavelength channels defined therein, where each of the optical wavelength channels is for propagating respective optical signals therein. The AWG optical device of course is capable of supporting narrower optical wavelength channels than the thin film counterpart due to the nature of operation of the AWG optical device.

While the AWG avoids the need for having fiber loops contained within the package, the AWG assembly is unfortunately physically fairly large in size. Additionally, AWG devices typically have optical fiber coupling ports located on opposite ends of the AWG device. Furthermore, when designing the optical packages for AWG devices, temperature stabilization becomes an important issue because these AWG devices are temperature sensitive. Often, thermoelectric cooler (TEC) modules are mounted within these optical device packages in order to facilitate temperature stabilization of the AWG device and the waveguide chip containing the AWG device in such a manner that tolerable optical wavelength channel shifts occur when the AWG is subjected to external temperature fluctuations.

Of course, AWG are not the only component useable within optical devices as a multiplexer or a demultiplexer, other possible solutions for CWDM systems include the use of Fiber Bragg Gratings (FBG)s, instead of thin film filter technology. Unfortunately, FBGs are known to be expensive due to temperature compensation required for accurate optical wavelength channel alignment of the FBG devices. Additionally, integrated optical waveguide based optical devices with large waveguide sizes typically require expensive packaging design to facilitate elaborate thermal compensation schemes to ensure that optical signals propagating through the optical device are not significantly altered by shifts in optical wavelength passbands provided by the optical device. Thus, using either FBGs or optical waveguide devices, such as an AWG, results in an expensive and typically large optical device.

Up to this point, the thin film filter has been the only rational choice for CWDM applications. A thin film filter has little packaging cost and therefore does not suffer the aforementioned disadvantages. Unfortunately, thin film filter implementations are not easily scalable to large channel counts, since the more optical channels that are added the larger the device becomes and the higher an insertion loss becomes for the device with more filters, especially for the optical signals making up a portion of the multiplexed or demultiplexed optical signal that propagates through all the thin film filters. Not to mention that thin film filters do not offer sufficient isolation between narrowly spaced optical wavelength channels. Thus, it would be advantageous to have a small, scalable, inexpensive and reliable alternative to the thin film filter technology, or AWG technology, for use within an optical devices that supports CWDM spaced optical wavelength channels.

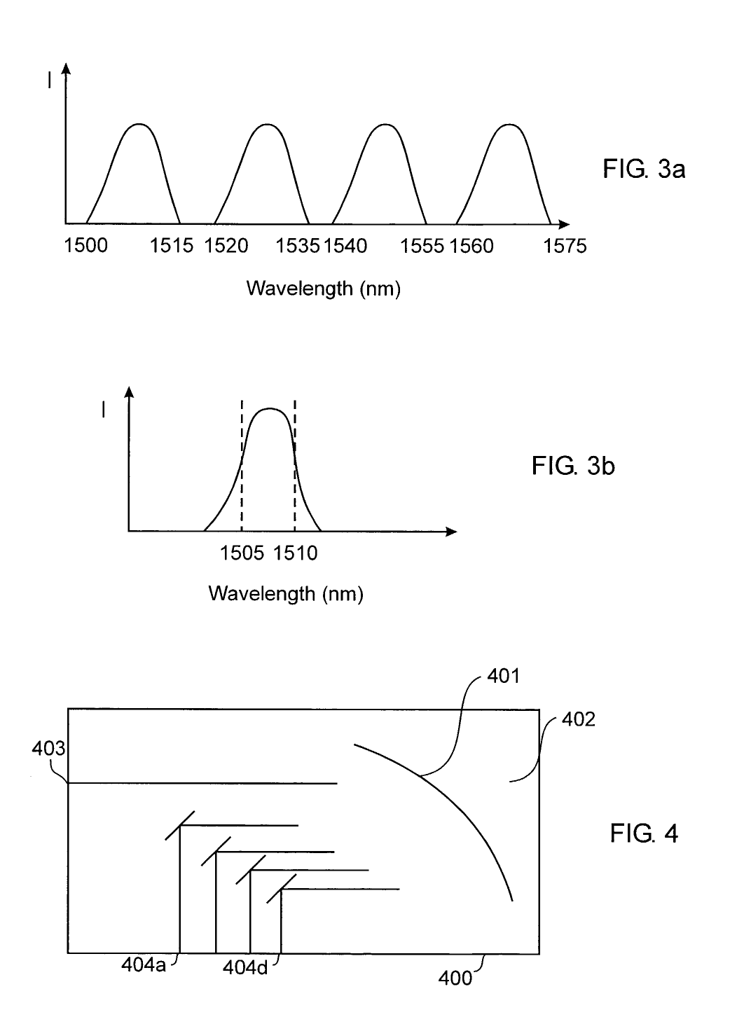

Referring to FIG. 3a, a CWDM optical wavelength passband spectral profile associated with a typical prior art optical device is shown. The profile illustrates four optical wavelength channels supporting passbands spaced with respect to a center wavelength thereof when the prior art optical device is used as a demultiplexer. The width of each optical wavelength passband is typically measured at a predetermined offset from a peak optical power level of the optical wavelength channel. For instance the width of the optical wavelength passband is measured at the −3 dB point, where the offset from the peak power level is 3 dB. Thus the width of this optical wavelength passband is the width in wavelength of the optical wavelength channel between the 3 dB points found at either side of the optical wavelength channel. Spacing between the optical wavelength channels is typically measured between a center wavelength of adjacent optical wavelength channels. Of course the spacing between CWDM optical wavelength channels, as well as the maximum channel widths used for optical communication within optical networks is typically set forth in standards provided by an International Telecommunication Union (ITU). Compliance to these standards ensures compatibility within optical networks between different network service providers; falling outside of these standards results in inefficient optical networks.

Referring to FIG. 3b, a wavelength profile of the output of a laser source for generating an optical signal for use within a CWDM optical network is shown. The profile illustrates the leading and falling edges of an optical signal generated by a laser source in terms of optical power with respect to a center wavelength of the laser source. As is shown in FIG. 3b, a majority of the optical power of the optical signal propagating within the optical wavelength channel is located between the vertical bars shown. Individual optical signals at different wavelengths are combined together and propagated through optical wavelength passbands defined by CWDM devices used within CWDM networks.

FIG. 4 illustrates an optical device for carrying out embodiments of the invention, a compact integrated optical grating optical device 400 that either functions as an optical muliplexer or an optical demultiplexer for use in CWDM optical networks. When the device 400 is used as an optical demultiplexer, a multiplexed optical signal supporting multiple optical signals is provided to an input port 403, in optical communication with an integrated wavelength dispersive element 401 in the form of an echelle grating. The wavelength dispersive element 401 disperses the multiple optical signals found in the multiplexed signal into individual optical signals at their respective wavelengths into one of their respective output ports 404a through 404d.

When the optical device 400 is used as a multiplexer, individual optical signals at respective different optical wavelengths are provide to input ports 404a through 404d. The wavelength dispersive element 301 combines the individual optical signals into a single multiplexed optical signal supporting the multiple optical signals at different optical wavelengths. The multiple optical signals are combined into the multiplexed optical signal in dependence upon the optical wavelength passbands defined by the optical device 400. Thus when the optical device is used in a first orientation then it functions as a multiplexer, and when used in a reverse direction the optical device functions as a demultiplexer.

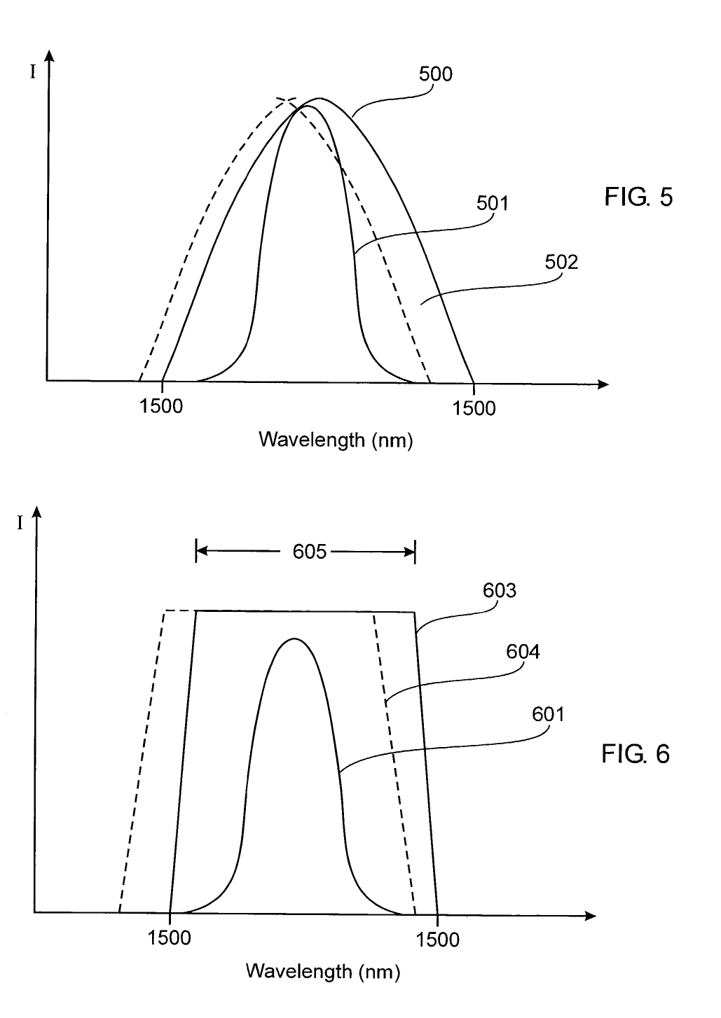

Referring to FIG. 5, an optical wavelength passband is shown 500 for a CWDM optical device that has no temperature compensation. A shifted optical wavelength passband 502 is shown for the same optical device after the device has been subjected to a temperature variation. An optical signal 501 centered about the optical wavelength channel is shown for reference purposes. The shifted optical wavelength passband 502 results from the CWDM optical device having its optical wavelength passband varied as the temperature varies to which the optical device is subjected. From this graph of FIG. 5 it is evident that the optical wavelength passband is centered at the center wavelength of the optical signal. As the temperature shifts however, the center of the optical wavelength passband shifts towards lower wavelengths, but the since the optical signal being propagated through the device is unchanged in its center wavelength, it is subjected to changes in the optical wavelength passband of the optical device in response to the temperature change. This shift in the optical wavelength passband causes a portion of the optical power of the optical signal 501 to become attenuated as a result thereof. Thus, as the wavelength response curve of the optical device shifts in wavelength, a fraction of the input signal in the lower wavelengths with respect to the center wavelength is less attenuated, and a fraction of the input signal in the upper wavelengths with respect to the center wavelength is more attenuated. This results in the optical signal to no longer have a symmetric profile about its center wavelength as a result of the shifting of the optical wavelength passband within the non-temperature stabilized optical device.

While any resulting variation in signal intensity, or optical signal profile, is not catastrophic, especially when optical networks have large optical power margins, it is often inconvenient and may render the optical device not useful if the optical signal is altered too much by the optical device. Of course, when optical devices exhibits these optical wavelength pasband shifts with respect to temperature, then effective optical power management to stabilize optical power levels in optical networks employing these optical devices becomes more cumbersome. Not to mention that these optical wavelength passband shifts often impact a portion of the optical power located about the center wavelength of the optical signal.

Referring to FIG. 6, a second set of optical wavelength response curves associated with a second CWDM optical device without temperature stabilization is shown. A shifted optical wavelength passband 604 is shown in overlay with an unshifted optical wavelength channel 603. The shifted optical wavelength response curve 602 results from the second CWDM optical device having its optical filtering properties varied in response to a temperature change. Again, an individual optical signal 601 is also shown for reference purposes.

As is evident from this graph, the shifted and unshifted optical wavelength passbands for the second optical device differ from those shown in FIG. 5. In this case the optical wavelength passband is flatter in the center, thus providing a wider passband 605, with edges thereof dropping off in optical power at a sharper rate than those of FIG. 5. To those of skill in the art this profile is described as having a “flat top.” Since the profile is “flat” across the width of the optical wavelength passband the wavelength response associated with a change in temperature for the uncompensated second optical device is not as dramatic when the second optical device is subjected to a temperature difference. When the second optical device is subjected to a temperature variation the shifted optical wavelength passband has little effect on the profile and optical power of the optical signal propagating therein. Clearly, having flat top passbands for the second optical device is more advantageous since the optical power of the input optical signal is not attenuated as much in response to the temperature change.

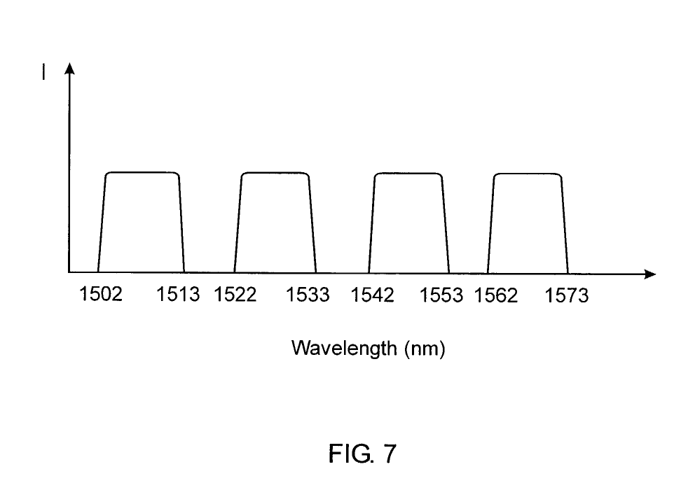

FIG. 7 illustrates four optical response curves for the second CWDM optical device supporting four optical wavelength channels, such as the optical device shown in FIG. 4. As is shown in this graph, the four optical wavelength channels are well spaced in terms of optical wavelength having a spacing common to that employed in CWDM optical networks.

It is known to those of skill in the art of producing echelle gratings integrated into a semiconductor substrate, that a center optical wavelength of the echelle grating typically varies up to 11 picometers per degree Celcius (pm/° C.). Under an assumption that the optical device using the echele grating, such as the optical device shown in FIG. 4, is subjected to a range of operating temperatures from 20° C. to 90° C., it is apparent that a total shift in optical wavelength of the center wavelength of the optical device may be as much as 770 pm or 0.77 nm in response thereto. In dependence upon whether the optical device has a flat top response or not, the resulting effect on the multiple optical signals propagating through the device may be significant or not. If the optical device exhibits a conventional response, such as that shown in FIG. 5, the an optical signal propagating through the device will be subject to attenuation in optical power as a result of the temperature change, if however the optical device has a flat top response (FIG. 6) then effects of temperature are decreased.

In comparison, if the flat-top profile of an optical wavelength passband is shifted by 770 pm, and an input optical signal is located approximately in the center of the optical wavelength passband prior to shifting with respect to temperature, then very little change in optical power results for an optical signal propagating through the optical wavelength passband defined by the optical device. Of course, it is known to those of skill in the art that for devices used in CWDM optical wavelength shifts of 500 pm are tolerable, however for optical devices used in DWDM systems, if the center of the optical wavelength passband varies by 500 pm then the result is generally considered disastrous because of crosstalk issues. In DWDM systems, individual optical wavelength channels are often less than 300 pm wide. In this case for the CWDM network a shift in optical wavelength of 550 pm for the optical wavelength passband is acceptable because the optical wavelength channels in CWDM optical networks are typically 11,000 pm wide and have a flat top.

In a first embodiment of the invention, an 8 channel CWDM device based upon an echelle grating, similar to a lower optical wavelength device shown in FIG. 4, is provided. The echelle grating, 401 for example, within the device is manufactured using silica on silicon technology. This echelle grating and the optical device in accordance with the first embodiment have been designed for “flat-top” behavior. Creating this flat top response results in slightly higher optical device insertion loss for each optical wavelength passband, however, it ensures that the insertion loss within a given optical wavelength passband for an optical signal propagating therein does not vary substantially in optical power when the optical device is subjected to the temperature change. Thus, using available production techniques, this device demonstrates thermal drift of less then 11 picometers per degree Celcius (pm/° C.), which is adequate for CWDM applications operating in most environments when the optical device is used without temperature compensation.

In a second embodiment, an AWG is used as opposed to the echelle grating. This grating features a convention Gaussian response. It will be apparent to one of skill in the art that an arrayed waveguide grating will satisfy the need for an effectively thermally insensitive CWDM device. However, as pointed out earlier, the AWG solution is more expensive. While an AWG solution is likely to be smaller than the thin film filter solution, shown in FIG. 2a, it is still fairly large simply due to the surface area required on the semiconductor substrate for manufacturing of the AWG.

Of course, though the optical wavelength passbands shown in FIG. 7 illustrate ideal square top optical wavelength passbands, such an optical wavelength passband profile is typically unachievable. Therefore, in the design of a device according to the invention, a careful balance is preferred between passband width and “flatness” of the square top passband. The actual channel region is a portion of the optical wavelength passband that still provides for optical isolation between adjacent optical signals even when the temperature changes within a predetermined range. Thus, it is preferred that the passband never shift more than half a distance (in wavelengths) of the optical wavelength channel width minus the passband width, when shifting towards both lower and higher optical wavelengths is possible. Also, it is preferred that the edges of the passband extend beyond a region in which the signal has maximum strength regardless of the temperature within the predetermined temperature range. Though, in the above description, this is achieved using wide “flat-top” passband design having steep drop-offs, this may also be achieved using less steep drop-offs while also maintaining a “flat-top” passband.

Advantageously, the optical device employing an echelle grating is small and due to the wide channel spacing associated with CWDM it does not require active thermal compensation when used under normal operating conditions within a CWDM optical network. Thus, given the aforementioned description, it is possible to determine a temperature range and passband spacing that is supportable with different integrated optical devices absent temperature compensation in order to provide an inexpensive CWDM optical device for use as either an optical multiplexer or optical demultiplexer.

Numerous other embodiments may be envisaged without departing from the spirit or scope of the invention.

What is claimed is:

1. A CWDM optical device comprising:
an input port for receiving a multiplexed CWDM optical signal supporting a plurality of optical signals each within a different optical wavelength channel;
a plurality of output ports; and,
an optical grating in optical communication with the input port, the optical grating for separating the plurality of optical signals into individual optical signals in dependence upon a wavelength of each of the optical signals, the CWDM optical device having an optical wavelength passband defined for each optical signal, the optical wavelength passband having a width for passing a substantial portion of optical power within each optical signal received at the input port to a respective output port from the plurality of output ports, the optical wavelength passband width for each optical wavelength channel being sufficient such that a change in temperature within a wide range of temperature values to which the CWDM optical device is subjected results in little or no change in optical power of each optical signal within a channel when propagated from the input port to a respective output port, the CWDM optical device additionally for supporting optical wavelength passbands that provide optical isolation between adjacent optical signals propagating within adjacent optical wavelength channels when the optical device is subjected to the temperature variation.

2. A device according to claim 1, wherein the device is optically bi-directional.

3. A device according to claim 2, wherein the wide range of temperature values is 125 degrees Celsius.

4. A device according to claim 2, wherein the wide range of temperature values is 75 degrees Celsius.

5. A device according to claim 2, wherein the wide range of temperature values is 35 degrees Celsius.

6. A device according to claim 2, wherein the CWDM optical device is manufactured using a semiconductor process.

7. A device according to claim 6, wherein the CWDM optical device is a waveguide structure.

8. A device according to claim 7, wherein the optical grating is an echelle grating.

9. A device according to claim 2, wherein the optical grating comprises optics for providing a substantially flat response for each optical wavelength passband when propagating a respective optical signal within an associated optical wavelength channel in response to the variation in temperature.

10. A device according to claim 9, wherein the optical grating has a plurality of optical wavelength passbands each having a substantially flat top amplitude profile with respect to wavelength.

11. A device according to claim 10, wherein each flat top amplitude profile is non-overlapping with an adjacent flat top amplitude profile within an amplitude range substantially above a noise floor of the optical device.

12. A device according to claim 2, wherein the optical device is other than used in conjunction with a temperature stabilizing controller.

13. A device according to claim 12, wherein the optical device is other than used in conjunction with a temperature stabilizing electrical circuitry.

14. A device according to claim 13, wherein the optical device is other than used in conjunction with a thermoelectric cooler module.

15. A device according to claim 2, wherein the spacing between the optical wavelength channels within the CWDM optical device is at least 700 pm.

16. A device according to claim 2, wherein the profile of the optical wavelength passband has a substantially flat response in terms of optical attenuation uniformity across the passband.

17. A method of filtering a CWDM optical signal supporting a plurality of optical wavelength channels, comprising the steps of:
providing an optical device for receiving the CWDM optical signal containing a multiple of optical signals at different optical wavelengths;
filtering an individual optical signal using an optical component having an optical wavelength passband having a center wavelength at a center wavelength of the optical signal for each of the multiple optical wavelength channels of a multiplexed signal received by the optical device;
in the absence of temperature stabilization unique to the optical component, other than substantially attenuating a filtered individual optical signal by the optical device when the optical device undergoes a temperature variation, and,
in the absence of temperature stabilization unique to the optical component, other than substantially attenuating an adjacent optical signal located adjacent the optical signal when the device undergoes a temperature variation.

18. A method according to claim 17, wherein the profile of the optical wavelength passband has a substantially flat response in terms of optical attenuation uniformity across the passband.

19. A method according to claim 17, wherein each passband has a flat top amplitude profile and is non-overlapping with an adjacent flat top amplitude profile within an amplitude range substantially above a noise floor of the optical device.

20. A method according to claim 17, wherein the temperature variation is 63 degrees Celsius from an average operating temperature.18.1. A method according to claim 17, wherein the temperature variation is 38 degrees Celsius from an average operating temperature.

21. A method according to claim 17, wherein the temperature variation is 18 degrees Celsius from an average operating temperature.

22. A method of filtering a CWDM optical signal supporting a plurality of optical wavelength channels, comprising the steps of:
providing an optical demultiplexer absent temperature stabilization thereof and having a plurality of passbands, each associated with an optical wavelength channel; and,
demultiplexing an optical signal having channel spacing such that a channel falls within a passband of the plurality of passbands and such that two of the optical signals other than fall within a same passband over an single period of the optical demultiplexer,
wherein variations in temperature to the optical demultiplexer that arise during normal use thereof result in a signal within a same wavelength channel falling within a same passband of the demultiplexer.

23. A method according to claim 17, wherein the profile of the optical wavelength passband has a substantially flat response in terms of optical attenuation uniformity across the passband.

24. A method according to claim 17, wherein each passband has a flat top amplitude profile and is non-overlapping with an adjacent flat top amplitude profile within an amplitude range substantially above a noise floor of the optical device.

25. A method according to claim 17, wherein the variation in temperature is 63 degrees Celsius from an average operating temperature.

26. A method according to claim 17, wherein the variation in temperature is 38 degrees Celsius from an average operating temperature.

27. A method according to claim 17, wherein the variation in temperature is 18 degrees Celsius from an average operating temperature.
